(19) United States
(12) Patent Application Publication
(10) Pub. No.: US 2026/0246994 A1
(43) Pub. Date: Aug. 20, 2026

(54) SYSTEMS AND METHODS FOR SYNCHRONIZED MULTI-ANGLE VIDEO RECORDING AND PLAYBACK

(71) Applicant: OnForm, Inc., Bellvue, CO (US)

(72) Inventor: Krishna Ramachandran, Lexington, MA (US)

(21) Appl. No.: 19/041,505

(22) Filed: Jan. 30, 2025

(51) Int. Cl. H04N 21/43; H04N 21/218; H04N 21/234; H04N 21/4363; H04N 21/8547

(52) U.S. Cl. CPC H04N 21/43072; H04N 21/21805; H04N 21/23406; H04N 21/43637; H04N 21/8547

(57) ABSTRACT

Systems and methods for synchronized multi-angle video recording and playback enable coordination of multiple recording devices through connected and disconnected device techniques. In a connected technique, a primary device coordinates with multiple secondary devices to capture synchronized video from different angles. Each device maintains a local rolling buffer and timestamps recordings using network-synchronized clock data. In a disconnected technique, devices operate independently using local device clocks previously synchronized with reliable time sources. When recordings are later uploaded to cloud storage, the system analyzes recording start times and automatically associates recordings that began within a predetermined time window as belonging to the same multi-angle session. Both techniques support various recording scenarios using standard consumer devices like smartphones and tablets. Sophisticated playback interfaces enable synchronized viewing of multiple angles with precise temporal alignment maintained across all views.

### BRIEF SUMMARY

This disclosure is generally directed to systems, methods, and computer-readable media relating to synchronized multi-angle video recording and playback. Capturing video recordings of events or activities from multiple angles may provide improved viewing experiences and more comprehensive documentation. However, coordinating multiple recording devices to capture synchronized multi-angle recordings presents several technical challenges. In traditional approaches, specialized equipment, complex setup procedures, or direct communication between recording devices may be required. These requirements may limit the accessibility and practicality of multi-angle recording for many users and scenarios.

Two distinct technical techniques for multi-angle video recording and synchronization are described herein. A first technique implements connected devices that coordinate through a primary device, while a second technique enables independent operation of disconnected devices with post-recording synchronization.

In the connected devices technique, a primary device may coordinate with multiple secondary recording devices to capture synchronized video from different angles. The primary device may discover secondary devices either through a local network or via cloud-based services. Configuration parameters may be distributed to all devices before recording begins, ensuring consistent video quality across all angles. When recording starts, each device may maintain a local rolling buffer of video data rather than streaming directly to the primary device. This local buffering technique may enable capture at maximum quality settings, such as 4K resolution and high frame rates, without network bandwidth constraints. Each device may timestamp its recordings using network-synchronized clock data, enabling precise temporal alignment during playback.

In the disconnected devices technique, recording devices may operate entirely independently without discovering or communicating with each other. Each device may rely on its local device clock, which may have previously synchronized with a reliable time source, to timestamp its recordings. When devices later connect to a network, they may upload their recordings to cloud storage. A cloud-based system may analyze recording start times and automatically associate recordings that began within a predetermined time window (e.g., three seconds) as belonging to the same multi-angle session. This technique may accommodate scenarios where devices record at different times or locations, or where network connectivity is limited or unavailable during recording.

Both techniques may provide significant advantages over traditional multi-angle recording techniques. The connected devices technique may enable coordinated recording without specialized equipment, using standard consumer devices such as smartphones and tablets. The local buffering technique may ensure optimal video quality while reducing network bandwidth requirements. The disconnected devices technique may further simplify multi-angle recording by eliminating the need for device coordination entirely. Users may record independently using whatever devices are available, and the system may automatically identify and associate related recordings based on timing data.

The systems and methods described herein may provide flexible implementations adaptable to various recording scenarios. Recording devices may be positioned around swimming pools for sports analysis, in theaters for performance documentation, at outdoor events for multiple perspectives, or in any other situation where multiple viewing angles may be beneficial. The system may accommodate different numbers of recording devices and various recording durations. Professional cameras, consumer smartphones, action cameras, and other recording devices may be seamlessly integrated into the same recording session.

Sophisticated playback interfaces may enable efficient review and analysis of synchronized multi-angle recordings. Users may view all angles simultaneously in a multi-pane display, with precise temporal alignment maintained across all views. Analysis tools may facilitate detailed examination of recorded content, while sharing features may enable distribution of synchronized multi-angle clips. The system may support playback across various devices and screen sizes, from mobile phones to desktop computers.

The disclosed techniques may solve several technical problems associated with multi-angle recording. By eliminating requirements for specialized equipment or complex setup procedures, the system may make multi-angle recording more accessible to a broader range of users. The local buffering technique may address video quality and bandwidth constraints, while the disconnected devices technique may solve coordination and connectivity challenges. Automatic timing analysis and association may reduce manual effort in organizing multi-angle content, while sophisticated playback tools may improve the utility of captured recordings.

In one example embodiment, a method includes transmitting, by a primary device, a trigger to initiate synchronized video recording across multiple video capture devices; causing each of the multiple video capture devices to begin recording respective videos from different angles of view using configuration parameters provided by the primary device in response to the trigger, wherein each of the multiple video capture devices maintains a rolling buffer of locally stored recorded video data and timestamps the respective videos using network-synchronized clock data; causing each of the multiple video capture devices to transfer their recorded videos to the primary device; and displaying the recorded videos from the multiple video capture devices in a synchronized multi-pane view on the primary device based on the timestamps.

In one example embodiment, the configuration parameters include at least one of resolution, frame rate, bit rate, exposure, shutter speed, and focus point.

In one example embodiment, the trigger comprises a voice command.

In one example embodiment, the trigger comprises input from a remote control bluetooth shutter device.

In one example embodiment, the trigger comprises artificial intelligence-based activity detection.

In one example embodiment, the multiple video capture devices are discovered by the primary device over a local network.

In one example embodiment, the multiple video capture devices are discovered by the primary device through an intermediary server using a shared database containing capture configuration data.

In one example embodiment, transferring the recorded videos comprises transmitting the videos over a local network.

In one example embodiment, transferring the recorded videos comprises uploading the videos from the multiple video capture devices to a cloud server and downloading the videos from the cloud server to the primary device.

In one example embodiment, the rolling buffer enables storage of video at maximum quality parameters including 4K resolution.

In one example embodiment, the rolling buffer enables storage of video at maximum quality parameters including a frame rate of 240 frames per second.

In one example embodiment, the primary device comprises a tablet computer.

In one example embodiment, the multiple video capture devices comprise at least one of: external cameras, tablet computers, and mobile phones.

In one example embodiment, displaying the recorded videos in the synchronized multi-pane view occurs as transfer of the videos completes.

In one example embodiment, the configuration parameters are provided to each video capture device before recording begins.

In one example embodiment, maintaining the rolling buffer comprises continuously recording and temporarily storing video data locally on each video capture device.

In one example embodiment, the network-synchronized clock data is obtained from a network time source before recording begins.

In one example embodiment, a method includes receiving, at a server, at least first video data from a first angle of view from a first video capture device and at least second video data from a second angle of view from at least a second video capture device, wherein the first video data includes a first recording start time obtained from a first reliable clock source, the second video data includes a second recording start time obtained from a second reliable clock source, and the first and second video capture devices operate independently without discovering each other; determining whether the first recording start time and the second recording start time occur within a predetermined time window; in response to determining the first and second recording start times occur within the predetermined time window: associating the first and second video data as belonging to a single multi-angle video capture session, updating a database to link the first and second video data, and synchronizing playback timing of the first and second video data based on their respective recording start times; and enabling synchronized playback of the first and second video data based on the synchronizing playback timing.

In one example embodiment, the predetermined time window is approximately three seconds.

In one example embodiment, the first and second video capture devices comprise at least one of: external cameras, tablet computers, and mobile phones.

In one example embodiment, receiving the first and second video data comprises receiving uploads from the first and second video capture devices when they connect to a network.

In one example embodiment, the first and second reliable clock sources comprise network-synchronized clocks.

In one example embodiment, synchronizing playback timing comprises offsetting playback start times of the first and second video data based on their respective recording start times.

In one example embodiment, the first and second video capture devices are associated with a same user account.

In one example embodiment, associating the first and second video data occurs automatically without user input.

In one example embodiment, the first and second video data are received at different times.

In one example embodiment, enabling synchronized playback comprises providing the synchronized first and second video data to a playback device.

In one example embodiment, the first and second video capture devices operate in an offline state during video capture.

In one example embodiment, the first and second reliable clock sources comprise local device clocks previously synchronized with a network time source.

In one example embodiment, receiving the first and second video data comprises receiving the data via a cloud storage service.

In one example embodiment, determining whether the recording start times occur within the predetermined time window occurs automatically when video data is received at the server.

In one example embodiment, synchronizing playback timing comprises maintaining relative time offsets between the first and second video data.

In one example embodiment, the first and second video data are captured without direct communication between the first and second video capture devices.

In one example embodiment, associating the first and second video data comprises storing metadata linking the video data in the database.

In one example embodiment, the method further includes receiving additional video data from additional video capture devices, each additional video data having a respective recording start time from a respective reliable clock source and being from a respective different angle of view; determining whether each respective recording start time occurs within the predetermined time window; in response to determining the respective recording start times occur within the predetermined time window: associating the additional video data with the single multi-angle video capture session, updating the database to link the additional video data, and synchronizing playback timing of all video data based on their respective recording start times; and enabling synchronized playback of all video data based on the synchronizing playback timing.

### BRIEF DESCRIPTION OF THE DRAWINGS

For a better understanding of the present invention, reference will be made to the following Detailed Description, which is to be read in association with the accompanying drawings:

FIG. 1A illustrates an example multi-angle recording system setup with cameras positioned around a swimming pool, in accordance with some example embodiments described herein.

FIG. 1B illustrates a system architecture block diagram showing internal components and data flows between primary and secondary devices, in accordance with some example embodiments described herein.

FIG. 2 illustrates a user interface display for configuring and controlling multi-angle video recording, in accordance with some example embodiments described herein.

FIG. 3 illustrates a synchronized playback interface showing multiple video angles with shared playback controls, in accordance with some example embodiments described herein.

FIG. 4 illustrates a network architecture and data flow diagram showing cloud services, local components, and recording devices, in accordance with some example embodiments described herein.

FIG. 5 illustrates a synchronized playback timing diagram showing how recordings with different start times are aligned during playback, in accordance with some example embodiments described herein.

FIG. 6 illustrates a system architecture for coordinating video recordings from independent devices that operate without direct communication, in accordance with some example embodiments described herein.

FIG. 7 illustrates a cloud-based playback system that processes and delivers synchronized multi-angle video content, in accordance with some example embodiments described herein.

FIG. 8 illustrates a mobile device interface for synchronized multi-angle video playback, in accordance with some example embodiments described herein.

FIG. 9 illustrates a flowchart showing operational steps for synchronized multi-angle video recording using connected devices, in accordance with some example embodiments described herein.

FIG. 10 illustrates a flowchart showing the video transfer process between devices and cloud storage, in accordance with some example embodiments described herein.

FIG. 11 illustrates a flowchart showing how configuration parameters are managed and distributed to recording devices, in accordance with some example embodiments described herein.

FIG. 12 illustrates a flowchart for the disconnected devices recording and synchronization process, in accordance with some example embodiments described herein.

FIG. 13 illustrates a flowchart detailing how the system handles videos received at different times from disconnected devices, in accordance with some example embodiments described herein.

FIG. 14 illustrates a flowchart showing how the system handles additional video data from multiple recording devices joining a synchronized session, in accordance with some example embodiments described herein.

FIG. 15 illustrates a computer system implementation that may represent the underlying hardware architecture for any of the system components described herein, in accordance with some example embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to certain components of the cameras, video encoding and decoding techniques, communication systems, and networks, have not been shown or described in order to avoid unnecessarily obscuring descriptions of the embodiments. Additionally, the various embodiments may be methods, systems, media, or devices. Accordingly, various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

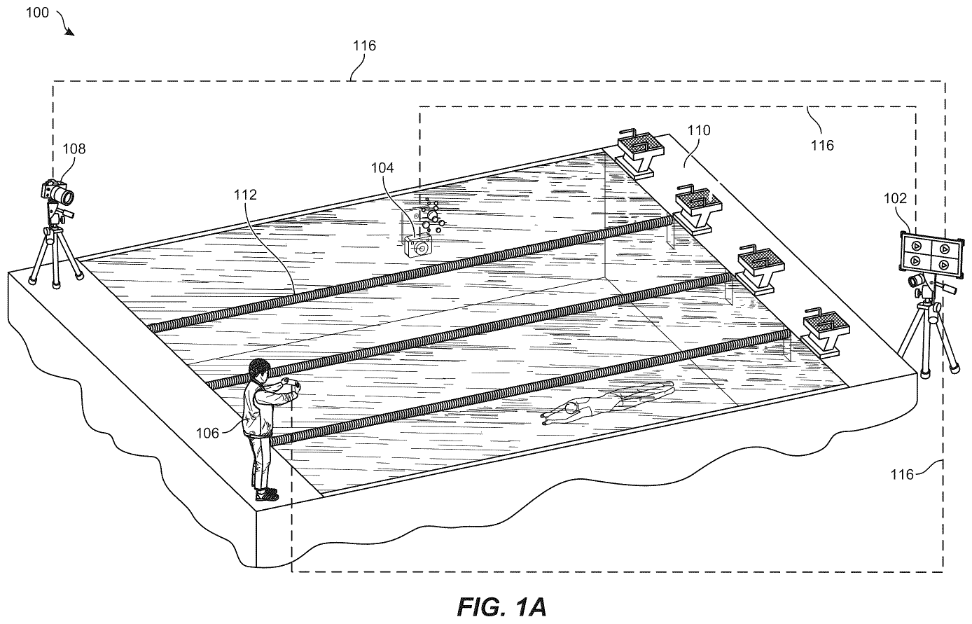

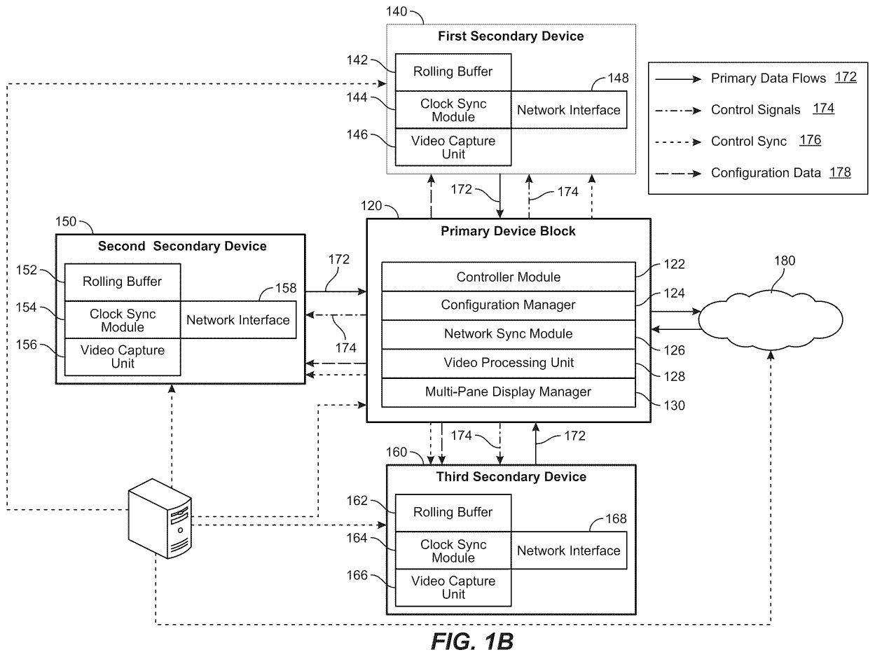

FIG. 1A illustrates an example multi-angle recording system 100 implemented in an example scenario of a swimming facility. A primary device 102, which may be implemented as a tablet computer, may be mounted on a tripod positioned at the pool edge. In one example embodiment, the primary device 102 may serve as the central coordination point for synchronized video recording across multiple video capture devices positioned at different angles around the swimming pool 110. While the example shown in FIG. 1A depicts a swimming facility implementation, the multi-angle recording system 100 may be configured for deployment across diverse recording scenarios and/or venues.

The system may utilize multiple secondary recording devices to capture different viewing angles of activities. In the swimming facility example, an underwater camera 104 may be mounted in a waterproof housing secured to the pool wall below the water surface. A person may operate a handheld device 106, such as a smartphone, from a standing position at poolside to capture video from a side angle perspective. A professional camera 108 may be mounted on a tripod and positioned at a lower angle at a diagonal corner of the pool, providing an additional perspective that captures activities along the length of the pool. Similar multi-angle configurations may be implemented at various sporting events where multiple camera angles enhance viewing experiences, such as basketball games with cameras positioned courtside, above the backboard, and/or in upper deck locations; football games with cameras along sidelines, end zones, and/or elevated positions; gymnastics competitions with cameras capturing floor routines, balance beam performances, and/or aerial maneuvers from different perspectives; and/or track and field events with cameras positioned along straightaways, curves, and/or finish lines.

In an example embodiment, the recording environment may incorporate various structural elements that appear across the different camera views. For the swimming facility implementation shown, the swimming pool 110 may be configured with multiple swim lanes separated by lane markers 112. Each camera position may be selected to capture different aspects of activities from their respective vantage points. The system may also be implemented in performance venues where capturing multiple viewpoints may be beneficial. Theater productions may utilize camera positions from the orchestra pit, balcony, and/or wings. Dance recitals may employ cameras capturing both full-stage views and close-up angles. Musical performances may incorporate cameras focused on different sections of an ensemble, soloists, and/or conductors. In outdoor settings, the system may be configured for capturing activities in open water such as surfing competitions, sailing races, and/or water skiing events, with cameras positioned on boats, drones, and/or waterproof housings.

Network connection indicators 116 may be established between the primary device 102 and each of the secondary recording devices (104, 106, 108). These network connections, represented by dotted lines in the figure, may enable the primary device 102 to coordinate synchronized recording activities across all cameras. The network connections may facilitate transmission of configuration parameters, control signals, and video data between the primary device and secondary devices. Such network-connected multi-angle recording may be particularly helpful in professional production environments, where the system may be deployed on movie sets, television productions, and/or commercial shoots. Cameras may capture primary action, secondary reactions, wide establishing shots, and/or intimate close-ups simultaneously. The system may be particularly helpful for documentary filmmaking, where multiple angles ensure comprehensive coverage of unpredictable events. In educational settings, the system may record lectures, demonstrations, and/or laboratory experiments from multiple perspectives to enhance learning experiences.

In some embodiments, each secondary recording device may maintain its position throughout a recording session while transmitting video data back to the primary device 102. In other embodiments, one or more of the cameras may move during recording. The underwater camera 104 may remain secured in its mounting position, the person holding device 106 may maintain a stable stance while recording, and the professional camera 108 may stay fixed on its tripod, all while maintaining their respective network connections 116 with the primary device 102. The system may also be adapted for personal use in capturing family events, celebrations, and/or home videos. Birthday parties may be recorded from different locations to capture guest reactions, gift opening, and/or party activities. Wedding ceremonies may utilize multiple cameras for capturing processionals, exchanges of vows, and/or guest perspectives. Sports training sessions may employ various camera positions to analyze technique, form, and/or performance from different angles. The flexibility of the system allows for creative camera placements and synchronized recording across virtually any scenario where multiple perspectives enhance the viewing experience.

FIG. 1B illustrates an example system architecture showing internal components and data flows between a primary device and multiple secondary devices in a multi-angle recording system. While this particular architecture provides one implementation example, various other system architectures may be utilized in different embodiments to achieve synchronized multi-angle recording functionality.

The primary device block 120 may be implemented through a software application or “app” that may be downloaded and installed on virtually any compatible smart device, such as a smartphone, tablet, or other mobile computing device. This software-based implementation may transform standard consumer devices into sophisticated multi-angle recording coordinators without requiring specialized hardware or factory configuration. The application may implement a controller module 122, configuration manager 124, network sync module 126, video processing unit 128, and multi-pane display manager 130 through software components that utilize the device's existing processing capabilities and hardware features.

In some embodiments, the network sync module 126 may facilitate device discovery through various mechanisms. Devices may be discovered over a local network, such as when all devices are connected to the same WiFi network. Alternatively, devices may be discovered through an intermediary server using a shared database containing capture configuration data, enabling discovery even when devices are on separate networks. This flexibility in device discovery may support both local and distributed recording scenarios.

Secondary recording devices may similarly be implemented through companion applications installed on standard consumer devices. A first secondary device 140, second secondary device 150, and third secondary device 160 may each execute software that configures their internal architectures while operating independently. These companion applications may implement rolling buffers (142, 152, 162) using the device's local storage capabilities. The rolling buffers may continuously record and temporarily store video data locally on each device, enabling storage of video at maximum quality parameters including 4K resolution and frame rates up to 240 frames per second. This local buffering technique may ensure optimal video quality without requiring continuous streaming to the primary device.

The clock sync modules (144, 154, 164) may maintain timing synchronization by obtaining clock data from network time sources before recording begins. These modules may leverage the device's existing timing systems, accommodating both network-synchronized clocks and reliable local device clocks that have previously synchronized with network time sources. Even when devices operate offline, their local clocks may maintain sufficient accuracy due to minimal drift characteristics of modern device timing systems.

Video capture units (146, 156, 166) may utilize built-in cameras while network interfaces (148, 158, 168) may take advantage of the device's wireless communication capabilities. This software-based technique may enable any compatible device to join the multi-angle recording system simply by installing the appropriate application. The modular nature of the software implementation may allow for easy integration of various device types, from professional cameras to consumer smartphones, without requiring specialized hardware modifications.

The system architecture may implement multiple types of data flows between devices, with cloud 180 optionally facilitating these communications. Primary data flows 172, shown as thick solid lines, may carry video data from secondary devices to the primary device either directly or through the cloud 180. Control signals 174, represented by thin dashed lines, may convey commands and status information through standard device communication protocols. Clock sync paths 176, indicated by dotted lines, may transmit timing data to maintain synchronization across all devices using existing device timing mechanisms. Configuration data 178, shown with dash-dot lines, may distribute recording parameters from the primary device to secondary devices through standard network protocols.

In some embodiments, the software-based architecture may support flexible scaling to accommodate various numbers of secondary devices while maintaining consistent data flow patterns and control hierarchies. The application-based implementation may enable users to easily add or remove recording devices by simply installing or uninstalling the companion app on additional devices. Standard consumer devices such as smartphones, tablets, action cameras, and digital cameras may be seamlessly integrated into the recording system through software installation, without requiring any hardware modifications or specialized equipment.

The modular software architecture may also facilitate updates and improvements through standard application update mechanisms, enabling new features, enhanced synchronization capabilities, and improved performance without hardware changes. This flexibility may allow the system to evolve and adapt to new devices, operating systems, and user requirements while maintaining compatibility with existing hardware platforms. For example, rolling buffer implementations may be optimized for new device capabilities, synchronization algorithms may be enhanced for improved timing accuracy, and new device discovery methods may be added to support additional networking scenarios.

The architecture may also support dynamic adaptation to varying network conditions and device capabilities. Rolling buffers may adjust their size based on available device storage, video quality settings may automatically optimize based on device capabilities, and data transfer methods may adapt based on available network bandwidth. This adaptability may enable robust operation across a wide range of devices and usage scenarios while maintaining synchronized recording capabilities.

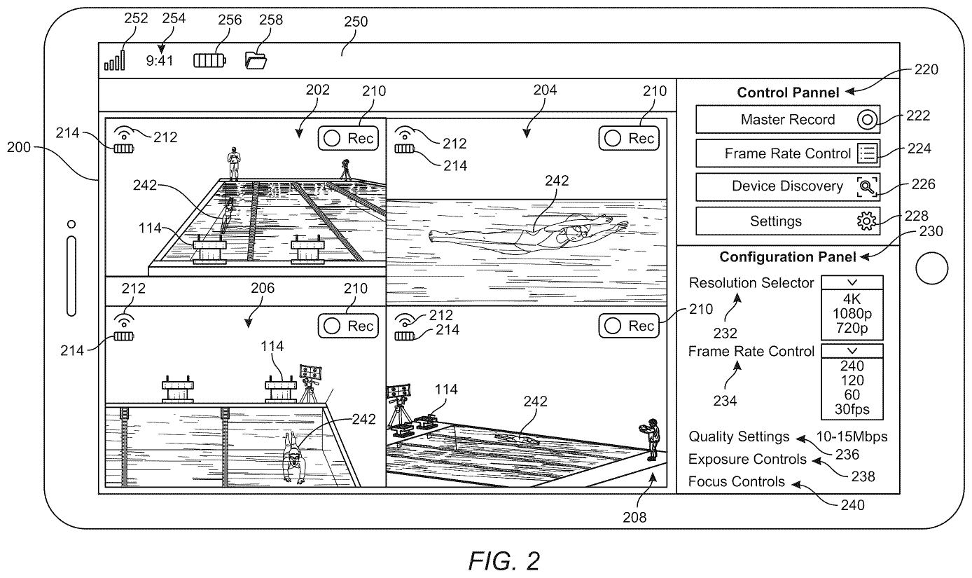

FIG. 2 illustrates an example user interface 200 for configuring and controlling multi-angle video recording. While this particular interface layout provides one implementation technique, various other interface designs, controls, parameters, and organizational structures may be utilized in different embodiments to achieve device configuration and recording control functionality.

The user interface 200 may incorporate multiple preview windows (202, 204, 206, 208) displaying real-time video feeds from different recording devices positioned around the swimming area. Preview window 202 may show video from the primary device camera, providing a wide-angle perspective of the pool. Preview window 204 may display the underwater camera feed, showing swimmer form and technique from below the surface. Preview window 206 may present video from the handheld device, offering a side view perspective, while preview window 208 may show footage from the professional camera positioned at a lower angle from the corner of the pool. Each preview window may include recording indicators 210 showing active recording status, connection status indicators 212 displaying network connectivity, and battery level indicators 214 monitoring device power status. Alternative embodiments may arrange preview windows differently, adjust their relative sizes, or dynamically reconfigure the layout based on the number of active recording devices and display constraints.

The user interface 200 may include a status bar 250 providing system information such as time 254, network status 252, and storage space 258. This information may be helpful for monitoring overall system operation and resource availability during recording sessions.

The user interface 200 may include a control panel 220 positioned along one edge, though alternative layouts may position controls differently. The control panel 220 may include a master record button 222 for initiating synchronized recording across all devices. Additional controls may include a device discovery button 226 for adding new recording devices to the session, and a settings button 228 for accessing additional system configurations. These controls may work in conjunction with the configuration manager 124 shown in FIG. 1B to distribute settings across connected devices.

In some embodiments, the user interface 200 may include a configuration panel 230 providing access to various recording parameters. The configuration panel 230 may slide into view when activated, though other embodiments may implement different methods for accessing configuration options. Resolution selector 232 may offer multiple resolution options, such as 4K, 1080p, and 720p, while frame rate control 234 may provide selections including 240 fps, 120 fps, 60 fps, and 30 fps. Quality settings 236 may allow adjustment of bitrate and compression parameters, while exposure controls 238 and focus controls 240 may enable fine-tuning of image capture characteristics. Alternative embodiments may include additional parameters, different parameter ranges, or various other configuration options based on device capabilities and recording requirements.

The user interface 200 may facilitate providing configuration parameters to each video capture device before recording begins, as the configuration manager 124 transmits these settings via control signals 174 shown in FIG. 1B. In some embodiments, the user interface 200 may support real-time parameter adjustments during recording, though some parameters may require recording to stop before changes take effect. The user interface 200 may provide visual feedback indicating whether parameters have been successfully applied to each connected device.

Alternative implementations of the user interface 200 may incorporate different organizational structures, such as tabbed configurations, hierarchical menus, or context-sensitive controls. Some embodiments may provide customizable interfaces where users may arrange controls based on their preferences or frequently used features. The user interface 200 may also adapt its layout based on the display size and orientation of the primary device. For example, on larger tablet displays, all preview windows may be visible simultaneously, while on smaller smartphone screens, the interface may implement swipeable views or collapsible panels to access different cameras and controls.

The user interface 200 may support various additional features beyond basic configuration. For example, some embodiments may include preset configurations for common recording scenarios, such as indoor sports, outdoor events, stage performances, or documentary filming. Advanced synchronization controls may allow fine-tuning of timing relationships between devices, while specialized recording modes may optimize settings for specific conditions such as in low light, fast motion, or underwater recording. The user interface 200 may also provide access to cloud storage settings, network configuration options, and device management features. Visual feedback mechanisms may include preview thumbnails, waveform monitors, histogram displays, or other tools for optimizing recording parameters.

In some embodiments, the user interface 200 may incorporate artificial intelligence or machine learning capabilities to suggest optimal configuration parameters based on recording conditions, scene content, or historical usage patterns. For example, the system may analyze lighting conditions, subject movement, and available network bandwidth to recommend appropriate resolution, frame rate, and quality settings. The user interface 200 may also learn from user preferences and commonly used configurations to streamline the setup process for similar recording scenarios. These intelligent features may help users achieve optimal recording quality while reducing the complexity of manual configuration.

The user interface 200 may also provide different levels of control complexity, from basic automatic settings to advanced manual configurations, accommodating users with varying levels of expertise. Beginner modes may present simplified options with automatic optimization, while advanced modes may expose detailed controls for professional users who desire precise control over recording parameters. This flexibility may enable the system to serve both casual users capturing family events and professional crews documenting commercial productions.

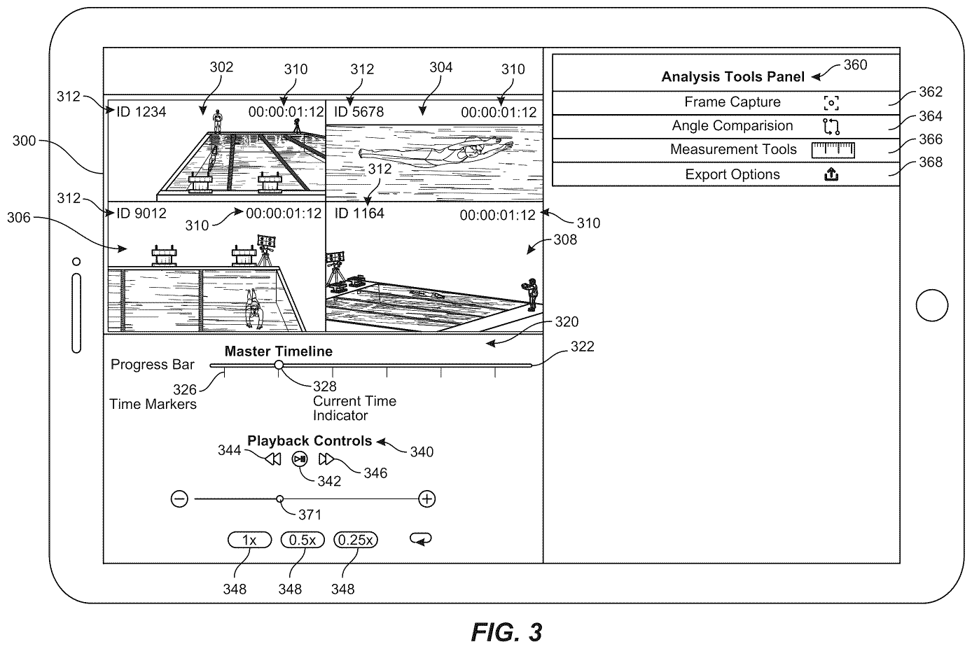

FIG. 3 illustrates an example synchronized playback interface 300 for viewing multi-angle video content. While this particular interface layout provides one implementation technique, various other playback interface designs, control arrangements, and viewing configurations may be utilized in different embodiments to achieve synchronized multi-angle video playback.

The playback interface 300 may incorporate a video display grid comprising four synchronized video panels (302, 304, 306, 308), each showing the same moment in time from different camera perspectives. The top-left panel 302 may display the wide-angle view captured by the primary device, while the top-right panel 304 may show the underwater camera perspective of the swimmer 242. The bottom-left panel 306 may present the side view recorded by the handheld device, and the bottom-right panel 308 may display footage from the professional camera positioned at the lower corner angle. Each panel may include a time code 310 displaying the current playback position (e.g., “00:00:01:12”) and a camera identifier 312 showing unique device IDs (e.g., “ID 1234”, “ID 5678”, “ID 1164”, “ID 9012”) to distinguish between recording sources.

A master timeline 320 may span the width of the interface below the video panels, providing unified playback control across all synchronized videos. The progress bar 322 may show the current playback position, while time markers 326 may indicate significant points along the timeline. A current time indicator 328 may highlight the precise moment being displayed across all panels. Alternative embodiments may implement different timeline visualizations or additional timing controls to aid in navigation and synchronization verification.

The playback interface 300 may include centrally positioned playback controls 340 beneath the timeline. These controls may include a video scrubber control knob 371, a previous frame button 344, play/pause button 342, and next frame button 346. Speed control options 348 may allow playback at various rates (0.25×, 0.5×, 1×), enabling detailed analysis of recorded content. Different embodiments may offer additional playback speeds or alternative control arrangements.

An analysis tools panel 360 may be positioned along the right side of the interface, though alternative layouts may position these tools differently. The panel may include features such as frame capture 362 for extracting still images, angle comparison 364 for detailed multi-view analysis, measurement tools 366 for analyzing form or technique, and export options 368 for sharing or saving selected content. The specific tools and their arrangement may vary across different embodiments based on intended use cases and user requirements.

In some embodiments, the playback interface 300 may maintain synchronization across panels through various mechanisms. For example, when navigating via the timeline or playback controls, all panels may update simultaneously to maintain temporal alignment. The interface may also support features such as synchronized slow motion playback, frame-by-frame advancement across all angles, and synchronized looping of selected segments.

The playback interface 300 may adapt to different viewing scenarios and device capabilities. On larger displays, all panels may be shown at equal size, while on smaller screens, the interface may allow users to maximize individual panels while maintaining smaller preview windows for other angles. Some embodiments may support dynamic panel arrangements, allowing users to customize the layout based on their analysis needs.

Additional features may include the ability to toggle individual panels on/off, apply various video enhancement filters, add annotations or markers, or generate synchronized multi-angle exports. The interface may also provide advanced analysis capabilities such as side-by-side comparison modes, overlaid timing measurements, or automated motion analysis tools.

The playback interface 300 may also support various data overlay options, such as performance metrics, timing data, or custom annotations. These overlays may be synchronized across all panels or applied selectively to specific views. The interface may also facilitate easy sharing of synchronized multi-angle clips, allowing users to export selected segments while maintaining temporal relationships between camera angles.

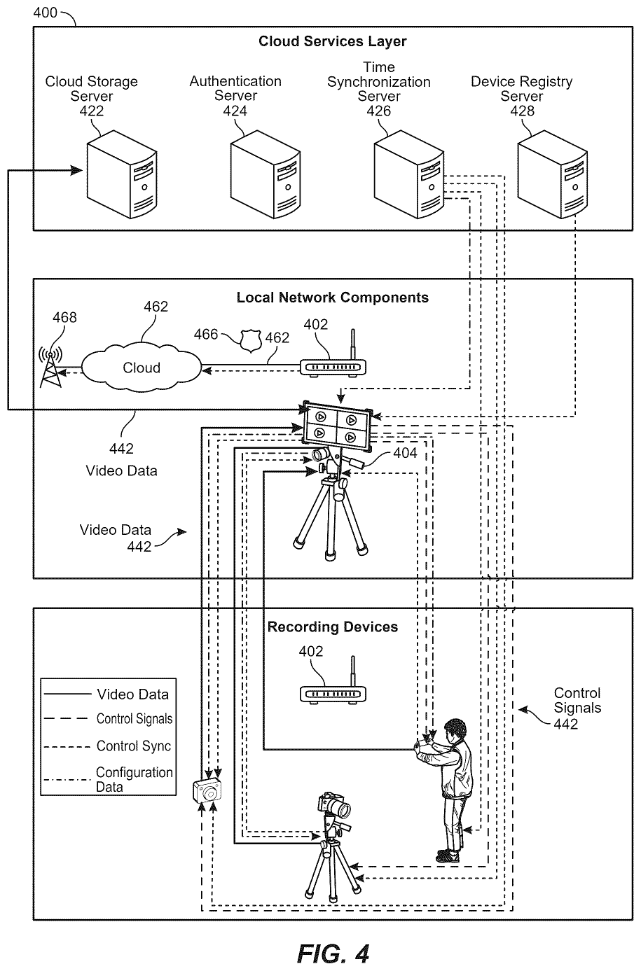

FIG. 4 illustrates an example network architecture and data flow configuration 400 for multi-angle video recording and transfer. While this particular architecture provides one implementation technique, various other network configurations, communication paths, and server arrangements may be utilized in different embodiments to achieve video data transfer and device coordination.

The architecture may include a cloud services layer 400 comprising multiple specialized servers. A cloud storage server 422 may handle video data storage and retrieval, while an authentication server 424 may manage device and user security. A time synchronization server 426 may provide timing references for coordinated recording, and a device registry server 428 may maintain information about connected devices and their capabilities. Alternative embodiments may combine or separate these server functions differently, or may include additional specialized servers for specific tasks.

In the local network components section, a WiFi router/access point 402 may serve as the central communication hub, connecting to the cloud services layer through an internet connection 462. A firewall/security layer 466 may protect local network communications, implementing various security protocols and access controls. The primary device 404 may connect to this local network infrastructure, coordinating with recording devices as detailed in FIG. 1B's architecture.

The system may support multiple video data transfer paths. Recording devices may transmit video data 442 to the primary device through the local network, enabling high-speed direct transfers when devices share the same network. Alternatively, video data may flow through the cloud storage server 422, particularly useful when devices are on different networks or when backup storage is desired. This flexibility in data paths may accommodate various recording scenarios and network conditions.

A 5G/cellular connection 468 may provide an alternate communication path to the cloud services layer. This redundant connectivity may enable system operation when WiFi is unavailable or unreliable, and may support mobile recording scenarios where devices move between networks. The system may automatically select the most appropriate connection path based on available bandwidth, latency requirements, and data transfer costs.

The architecture may implement various types of control signals, timing synchronization, and configuration data flows similar to those shown in FIG. 1B, but expanded across the broader network infrastructure. Control signals may coordinate recording operations, while clock synchronization maintains temporal alignment across devices. Configuration data may flow from the primary device to recording devices through either local or cloud-based paths.

In some embodiments, when video transfer occurs over a local network, the system may utilize high-speed local connections to minimize transfer times and reduce internet bandwidth usage. The architecture may support simultaneous transfers from multiple recording devices, with the primary device managing transfer queues and bandwidth allocation. Local transfer may be particularly efficient for high-resolution video files that might be challenging to transfer over internet connections.

When cloud-based transfer is employed, recording devices may upload their videos to the cloud storage server 422, from which the primary device may then download them. This technique may provide additional flexibility in handling transfers, as devices need not be simultaneously connected to the same network. The cloud storage server 422 may also implement various optimization techniques, such as adaptive bitrate streaming or progressive downloads, to enhance transfer efficiency.

The architecture may support dynamic adaptation to changing network conditions. For example, if a local network connection becomes congested or unavailable, the system may automatically switch to cloud-based transfer or 5G connectivity. Similarly, if cloud services become temporarily unavailable, the system may prioritize local network transfers. This adaptability may help ensure reliable video transfer across various operating conditions.

Security features may be implemented throughout the architecture. The firewall/security layer 466 may protect local network communications, while the authentication server 424 may verify device and user identities. Encrypted connections may be used for all data transfers, whether local or cloud-based, and access controls may restrict video sharing to authorized devices and users.

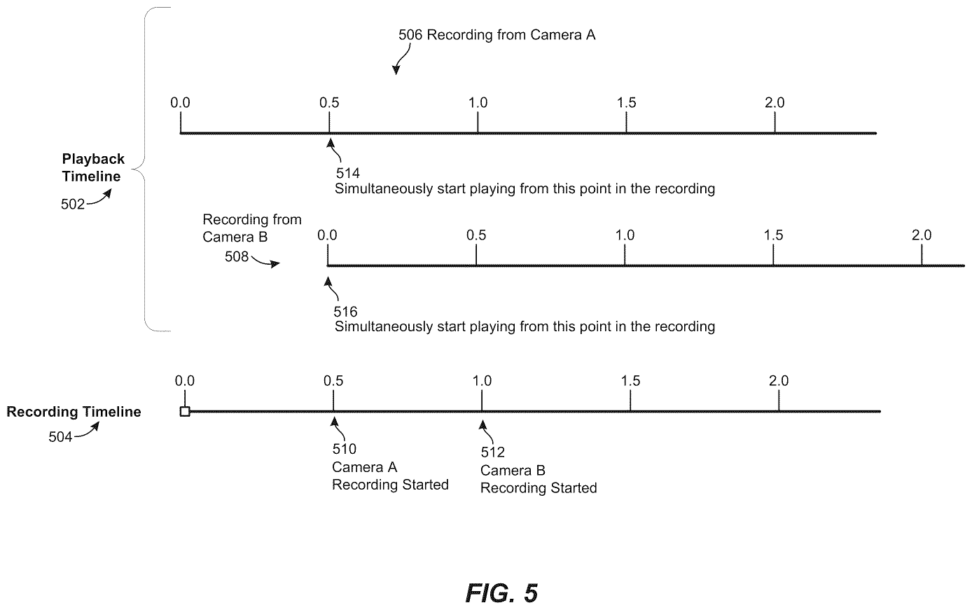

FIG. 5 illustrates an example synchronization timing diagram showing how recordings from different cameras are aligned for synchronized playback despite having different recording start times. While this particular timing arrangement provides one implementation technique, various other synchronization mechanisms and timing relationships may be utilized in different embodiments to achieve synchronized playback.

The diagram includes a playback timeline 502 that comprises a timeline representing the recording from Camera A 506 and another timeline representing the recording from Camera B 508, each marked in half-second increments from 0.0 to 2.0 seconds. Below this, a master recording timeline 504 shows the actual timing of recording events. This timeline demonstrates how recordings that begin at different times are synchronized during playback.

In the present example, a recording from Camera A 506 starts at time 0.5 seconds, as indicated by Camera A recording started marker 510. Subsequently, a recording from Camera B 508 begins at time 1.0 seconds, as shown by Camera B recording started marker 512. When initiating synchronized playback, the system first analyzes the recording start time of each camera by examining timestamps associated with each recording. The system identifies that Camera A's recording started at 0.5 seconds and Camera B's recording started at 1.0 seconds on the master timeline.

The synchronization algorithm then determines which camera started recording last in this case, Camera B at 1.0 seconds. This latest recording start time becomes the reference point for synchronizing all recordings. The algorithm calculates the time difference between each camera's recording start time and this reference point. For Camera A, this difference is 0.5 seconds (1.0 seconds minus 0.5 seconds).

To achieve synchronized playback, the algorithm applies these calculated offsets to the playback start points within each recording. For Camera A's recording, the system begins playback from point 514, which is 0.5 seconds into Camera A's recording. This effectively skips the first 0.5 seconds of Camera A's recording to synchronize with Camera B's start time. For Camera B's recording, the system begins playback from point 516 at the beginning of its recording since it started last. When playback begins, both video streams show events occurring at the same actual time, with their content temporally aligned despite their different recording start times.

In some embodiments, the synchronization mechanism may store these calculated offset values and apply them throughout the playback session. This enables consistent synchronization during playback operations such as pause, rewind, or fast-forward. The system maintains the relative offset relationships between recordings even as the user navigates through the content.

The timing diagram also demonstrates how the system handles recordings of different durations. After synchronization is established using the calculated offsets, the system continues to maintain temporal alignment by referencing all playback positions to the master timeline 502, ensuring proper alignment of all video content while managing any gaps or overlaps in recording times.

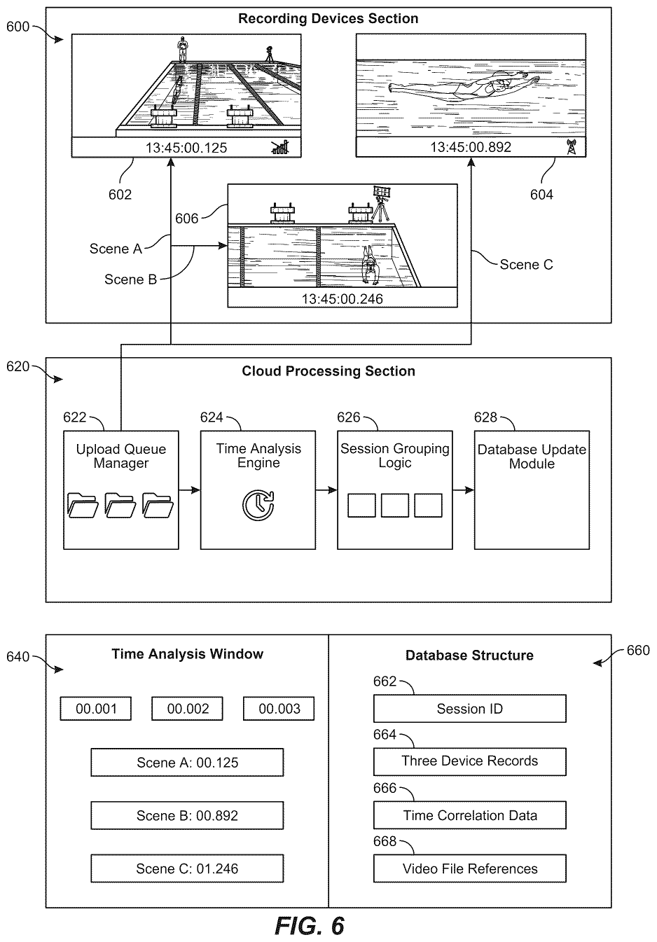

FIG. 6 illustrates an example system architecture 600 for coordinating video recordings from independent devices that operate without direct communication or discovery of each other. While this particular architecture provides one implementation technique, various other system configurations and processing arrangements may be utilized in different embodiments to achieve post-recording synchronization.

The recording devices section 600 shows three independent recording scenarios. Scene A 602 indicates a first recording starting at time “13:45:00.125” operating in offline mode, Scene B 604 shows a second recording starting at “13:45:00.892” with cellular connectivity, and Scene C 606 displays a third recording starting at “13:45:01.246” marked as having no network connection. In the present example, each scene represents a different angle of the same event, though the devices operate independently without knowledge of each other's existence or recording status.

A cloud processing section 620 implements the post-recording analysis and synchronization workflow through four main components arranged sequentially. An upload queue manager 622 handles incoming video files as devices connect to the network and transfer their recordings. These uploads may occur at different times-some immediately after recording if network-connected, others potentially days or weeks later when offline devices eventually establish connectivity.

The time analysis engine 624 examines the recording start times from the uploaded videos. Following this, a session grouping logic 626 analyzes whether multiple recordings fall within a predetermined time window, such as three seconds in this implementation. For example, the engine identifies that Scene A's start time of 00.125 seconds, Scene B's start time of 00.892 seconds, and Scene C's start time of 01.246 seconds all fall within a three-second window, suggesting they likely captured the same event from different angles.

The time analysis window 640 provides a visual representation of this temporal analysis, plotting the recording start times on a timeline marked in milliseconds. When recordings are determined to be temporally related, the database update module 628 creates and maintains the relationships between these recordings in the database structure 660.

The database structure 660 organizes the related recordings using a session ID 662 as the primary linking mechanism. Under each session, the system maintains three device records 664 containing information about each recording device and its captured content. Time correlation data 666 stores the precise timing relationships between the recordings, while video file references 668 maintain links to the actual video content.

In some embodiments, the system may implement various algorithms for time window analysis and session grouping. For example, the system may adjust the time window size based on the type of event being recorded, the number of devices typically involved, or historical patterns of multi-angle recordings. The system may also consider additional factors beyond just start times, such as recording duration, location data, or user account associations.

The cloud processing section 620 may also handle various edge cases and special scenarios. For instance, if additional recordings are uploaded later with matching timestamps, the system may automatically associate them with existing sessions. The system may also manage scenarios where recordings partially overlap in time or where multiple recording sessions occur close together temporally.

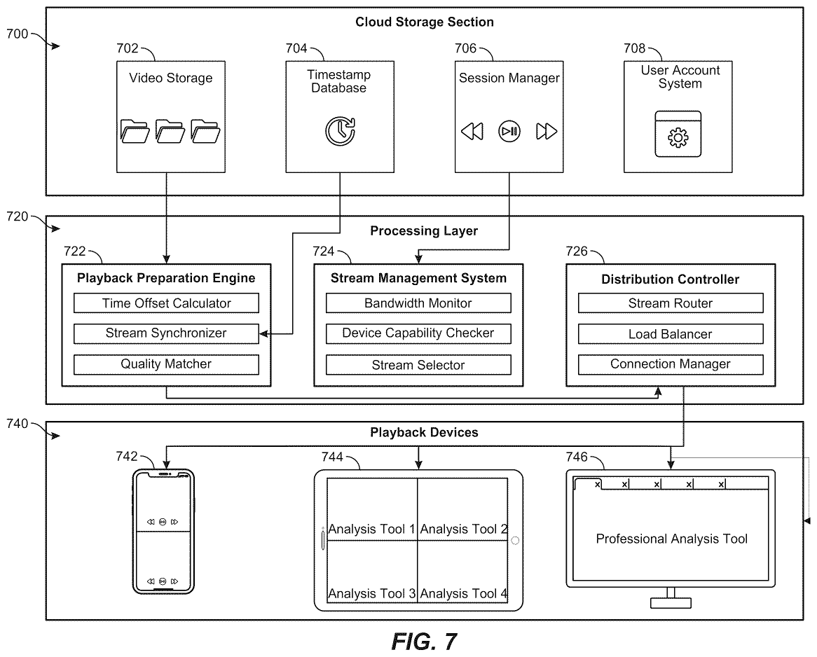

FIG. 7 illustrates an example cloud-based playback system that processes and delivers synchronized multi-angle video content recorded by independent devices. While this particular system architecture provides one implementation technique, various other configurations and processing arrangements may be utilized in different embodiments.

The cloud storage section 700 comprises four integrated components. A video storage component 702 stores the actual video files uploaded from various devices, while a timestamp database 704 maintains the precise recording start times obtained from each device's local clock. Importantly, these timestamps rely on the device's own reliable clock that was previously synchronized with a network time source before going offline. The session manager 706 coordinates playback sessions, while the user account system 708 manages access and associations between recordings and users.

The processing layer 720 implements the core synchronization and playback preparation logic through three main components. The playback preparation engine 722 includes a time offset calculator that processes the recording start times stored in the timestamp database 704. For example, if one video started recording at 1:00:00 PM and another at 1:00:02 PM, the engine determines they fall within the system's three-second window and calculates the necessary playback offsets. A stream synchronizer then implements these offsets during playback-if one video started recording 0.5 seconds before another, it begins playback 0.5 seconds into its recording to maintain synchronization. For example, see FIG. 6 which shows an example of this process. A quality matcher optimizes video streams based on playback device capabilities.

The stream management system 724 monitors playback conditions through its bandwidth monitor, device capability checker, and stream selector components. This system ensures smooth delivery of synchronized content across various network conditions and device types. The distribution controller 726 then manages the actual content delivery through its stream router, load balancer, and connection manager.

The system supports multiple playback devices 740, including mobile devices 742, tablets 744, and desktop browsers 746. Each device receives synchronized streams where playback timing has been automatically adjusted based on the original recording start times. For example, when playing back videos recorded at 1:00:00 PM and 1:00:02 PM, the system automatically starts playing the first video two seconds into its recording to synchronize with the second video's start time.

In some embodiments, the playback system may implement various professional analysis tools for detailed content review. These may include features for analyzing motion, comparing angles, measuring performance metrics, or annotating content across synchronized views. The interface may provide different analysis tool sets depending on the playback device and use case.

The system accounts for the fact that recording devices may have been offline during capture, relying on their local device clocks that were previously synchronized with network time sources. Since modern smart devices maintain reliable local clocks with minimal drift, the system can trust these timestamps for post-recording synchronization, even when videos are uploaded days or weeks after recording.

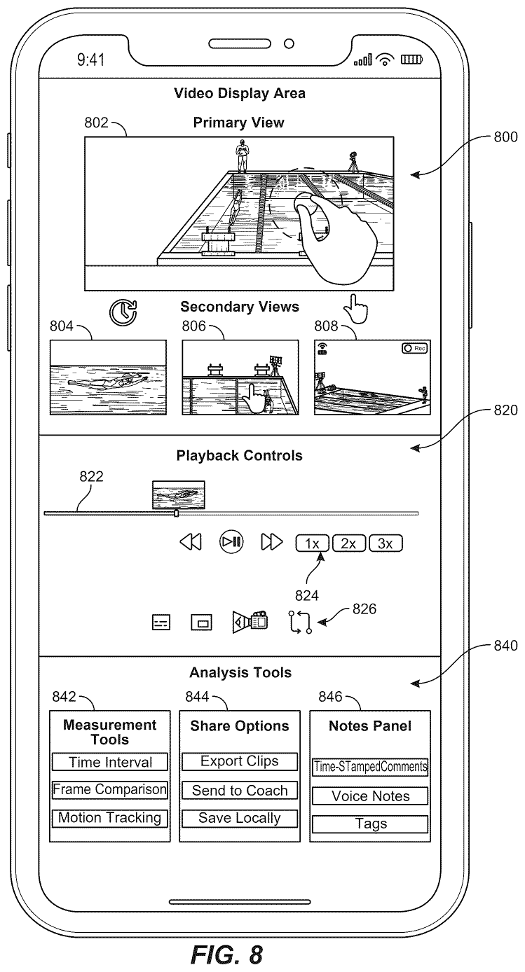

FIG. 8 illustrates an example mobile device interface 800 specifically designed for synchronized multi-angle video playback on smartphones and tablets. While this particular interface layout provides one implementation technique, various other mobile interface designs and control arrangements may be utilized in different embodiments.

The video display area 800 implements a flexible viewing layout optimized for mobile screens. The primary view 802 occupies the majority of the upper screen space, showing the main selected camera angle. Secondary views 804, 806, and 808 are arranged as a horizontal strip below, allowing quick access to alternate angles. Each view maintains precise synchronization with others, displaying the same moment in time from different perspectives, even though the original recordings may have started at slightly different times.

The interface includes playback controls 820 strategically positioned for easy one-handed operation. A central timeline scrubber 822 enables precise navigation through the synchronized content. The interface implements time-synced playback controls 824 that maintain temporal alignment across all angles even during scrubbing or speed adjustments. A speed control section offers multiple playback rates (1×, 2×, 3×) through button 826, useful for detailed analysis or quick content review.

Analysis tools 840 provide specialized features for content examination. Measurement tools 842 may include time interval analysis, frame comparison capabilities, and motion tracking features. Share options 844 facilitate easy distribution of synchronized multi-angle clips, allowing users to export selected segments while maintaining temporal relationships between angles. A notes panel 846 supports documentation through time-stamped comments, voice notes, and custom tags that remain synchronized across all camera angles.

In some embodiments, the interface may support gesture-based interactions optimized for touch screens. Users may swipe between angles, pinch to zoom, or use two-finger gestures for playback control. The interface may automatically adjust its layout based on device orientation and screen size, ensuring optimal viewing experiences across different mobile devices.

The interface may also incorporate advanced analysis capabilities suitable for mobile use. Time-stamped comments may be anchored to specific moments across all synchronized angles, enabling detailed documentation of observations. Voice notes may be particularly useful for hands-free analysis, while tags may help organize and categorize content for later reference.

The system maintains precise synchronization during all playback operations, compensating for the original timing differences between recordings. For example, if one recording started half a second before another, the interface automatically adjusts playback start points to maintain temporal alignment, ensuring that all angles show the same moment regardless of their original recording start times.

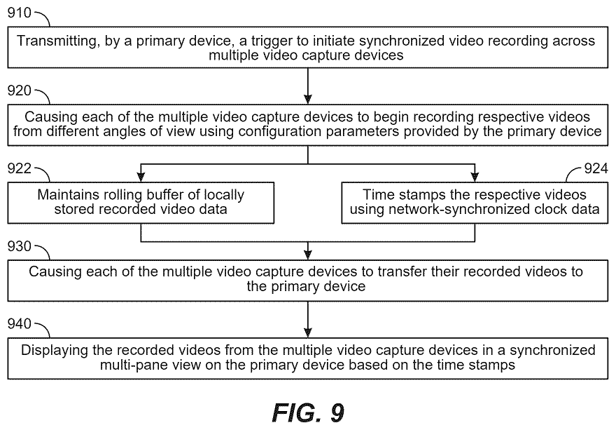

FIG. 9 illustrates an example method flowchart showing operational steps for synchronized multi-angle video recording using connected devices. While this particular process flow provides one implementation technique, various other operational sequences and combinations of steps may be utilized in different embodiments to achieve synchronized recording functionality.

The process begins at block 910 with transmitting, by a primary device, a trigger to initiate synchronized video recording across multiple video capture devices. This trigger initiates a coordinated recording session, ensuring all connected devices begin capturing video in a synchronized manner.

Following the trigger, at block 920, the method proceeds to causing each of the multiple video capture devices to begin recording respective videos from different angles of view using configuration parameters provided by the primary device. These configuration parameters establish consistent recording settings across all devices to maintain quality and compatibility.

The method then implements two parallel operations that occur during the recording process. In one parallel operation shown in block 922, each device maintains a rolling buffer of locally stored recorded video data. This local buffering technique enables high-quality video capture by storing content directly on each device rather than streaming it continuously to the primary device. Simultaneously, as shown in block 924, each device timestamps the respective videos using network-synchronized clock data, establishing precise temporal relationships between recordings from different angles.

At block 930, the process includes causing each of the multiple video capture devices to transfer their recorded videos to the primary device. This transfer may occur after recording completes or during recording, depending on network conditions and system configuration.

The method concludes at block 940 with displaying the recorded videos from the multiple video capture devices in a synchronized multi-pane view on the primary device based on the timestamps. The system uses the embedded timestamps to align the videos temporally, ensuring all angles display the same moment despite any slight variations in initial recording start times.

In some embodiments, the process may include additional error checking, verification steps, or alternative paths based on network conditions or device capabilities. The method may also adapt its operation based on the number of connected devices, available network bandwidth, or specific recording requirements for different scenarios.

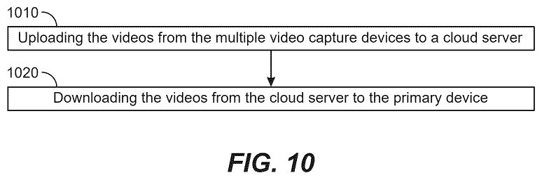

FIG. 10 illustrates an example method flowchart showing the video transfer process between devices and cloud storage. While this particular transfer sequence provides one implementation technique, various other transfer mechanisms and paths may be utilized in different embodiments.

The process includes two primary steps specifically focused on the movement of recorded video data. At block 1010, the method involves uploading the videos from the multiple video capture devices to a cloud server. This upload operation may occur at different times for different devices, depending on their network connectivity and when they establish a connection to the cloud server.

Following the upload, at block 1020, the process continues with downloading the videos from the cloud server to the primary device. This two-step transfer through cloud storage provides flexibility in how and when videos are transferred between devices, removing the requirement for direct device-to-device communication or simultaneous network connectivity.

In some embodiments, this cloud-based transfer technique may support various scenarios where direct device-to-device transfer is impractical or impossible. For example, when devices record videos in locations with limited or no network connectivity, they may upload their content once they regain network access. Similarly, when devices are on different networks or physically separated, the cloud server acts as an intermediate storage and transfer point.

The method may implement various optimization techniques during both upload and download operations. These may include compression, chunked transfer, parallel downloads, or adaptive bitrate selection based on network conditions. The system may also implement verification steps to ensure complete and accurate transfer of video data.

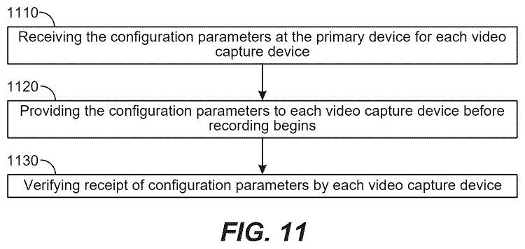

FIG. 11 illustrates an example method flowchart showing how configuration parameters are managed and distributed to recording devices. While this particular configuration process provides one implementation technique, various other parameter management and distribution methods may be utilized in different embodiments.

The process begins at block 1110 with receiving the configuration parameters at the primary device for each video capture device. These parameters establish the recording settings that will be used across all devices participating in the synchronized recording session. The configuration parameters may include resolution settings, frame rates, bit rates, exposure settings, shutter speeds, focus points, and other recording characteristics that affect video quality and compatibility.

At block 1120, the method proceeds to providing the configuration parameters to each video capture device before recording begins. This pre-recording distribution ensures all devices are properly configured before the synchronized recording session starts. By establishing these settings in advance, the system helps maintain consistent video characteristics across all recording angles.

The process includes a verification step at block 1130, where the system verifies receipt of configuration parameters by each video capture device. This confirmation step helps ensure all devices are properly configured before recording begins, reducing the risk of recording failures or inconsistent video characteristics.

In some embodiments, the configuration process may adapt to different device capabilities and limitations. For example, if certain devices cannot support specific quality settings, the system may adjust parameters to ensure compatibility while maintaining the highest possible quality for each device. The method may also include fallback settings or alternative configurations if certain parameters cannot be applied.

The verification process may implement various error checking and recovery mechanisms. If configuration parameters fail to apply correctly, the system may attempt to reapply settings, use alternative parameters, or alert users to potential configuration issues before recording begins.

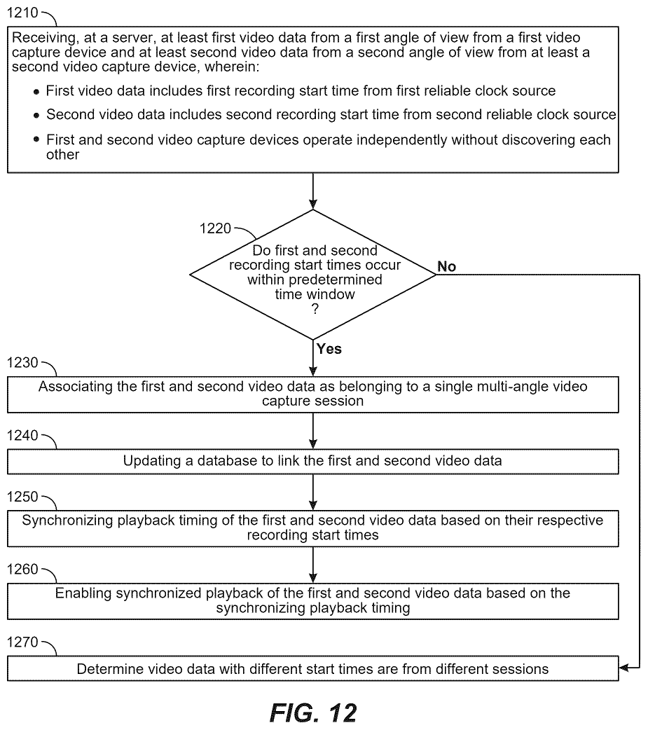

FIG. 12 illustrates an example method flowchart for the disconnected devices recording and synchronization process, implementing key aspects of post-recording video association. While this particular process flow provides one implementation technique, various other synchronization and association methods may be utilized in different embodiments.

The process begins at block 1210 with receiving, at a server, video data from multiple independent sources. Specifically, the server receives at least first video data from a first angle of view from a first video capture device and at least second video data from a second angle of view from at least a second video capture device. Each video includes critical timing information: the first video data includes a first recording start time from a first reliable clock source, and the second video data includes a second recording start time from a second reliable clock source. Importantly, the first and second video capture devices operate independently without discovering each other, using their respective local device clocks that were previously synchronized with reliable time sources.

At decision block 1220, the system determines whether the first and second recording start times occur within a predetermined time window. For example, the system checks if both recordings started within three seconds of each other, though this window may be adjusted based on specific use cases.

If the recordings fall within the time window (YES path), the process continues through several association and synchronization steps. At block 1230, the system associates the first and second video data as belonging to a single multi-angle video capture session. Following this, at block 1240, the system updates a database to link the first and second video data, creating a permanent association between these independently recorded videos.

The process then moves to block 1250, where the system synchronizes playback timing of the first and second video data based on their respective recording start times. For example, if one recording started at 1:00:00 PM and another at 1:00:02 PM, the system calculates the necessary offset to align their playback. At block 1260, the system enables synchronized playback of the first and second video data based on the synchronizing playback timing, allowing viewers to see both angles in temporal alignment.

If the recordings do not fall within the time window (NO path), the process moves to block 1270, where the system determines that video data with different start times are from different sessions. This separation helps prevent false associations between unrelated recordings.

In some embodiments, the system may consider additional factors beyond just recording start times when determining video relationships. These factors might include recording location, user account association, event type, or other metadata that could indicate related recordings. The system may also implement various algorithms for handling edge cases, such as when recordings partially overlap in time or when multiple recording sessions occur close together temporally.

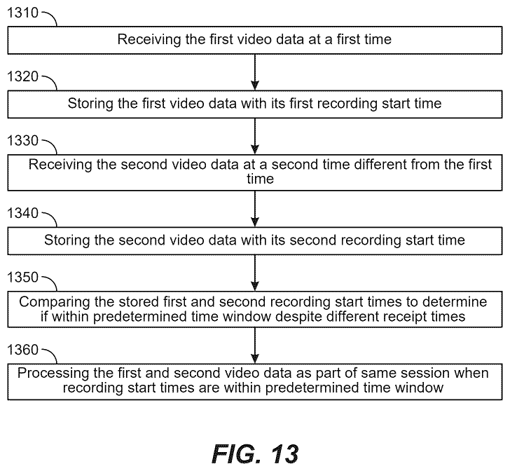

FIG. 13 illustrates an example method flowchart detailing how the system handles videos received at different times from disconnected devices. While this particular handling process provides one implementation technique, various other methods for managing asynchronous video uploads may be utilized in different embodiments.

The process begins at block 1310 with receiving the first video data at a first time. For example, a first device might upload its recording immediately after capture due to having immediate network connectivity. At block 1320, the system stores the first video data with its first recording start time, maintaining the precise timestamp information from when the recording began.

Following this, at block 1330, the system receives the second video data at a second time different from the first time. This second upload might occur hours, days, or even weeks after the first upload-for instance, when a previously offline device finally connects to the network. At block 1340, the system stores the second video data with its second recording start time, preserving its original timestamp information.

At block 1350, the system compares the stored first and second recording start times to determine if they fall within the predetermined time window, despite their different receipt times. This comparison relies on the original recording timestamps rather than upload times, enabling the system to identify related recordings even when they're uploaded far apart. For example, if one video started recording at 1:00:00 PM and another at 1:00:02 PM, they fall within the three-second window regardless of when they were uploaded to the system.

The process concludes at block 1360 with processing the first and second video data as part of the same session when their recording start times are within the predetermined time window. This processing includes creating the necessary database associations and preparing the videos for synchronized playback.

In some embodiments, the system maintains flexible time window parameters that may be adjusted based on the type of event being recorded, user preferences, or specific use case requirements. The system may also implement various verification steps to ensure timestamp accuracy and validity, particularly for devices that have been offline for extended periods.

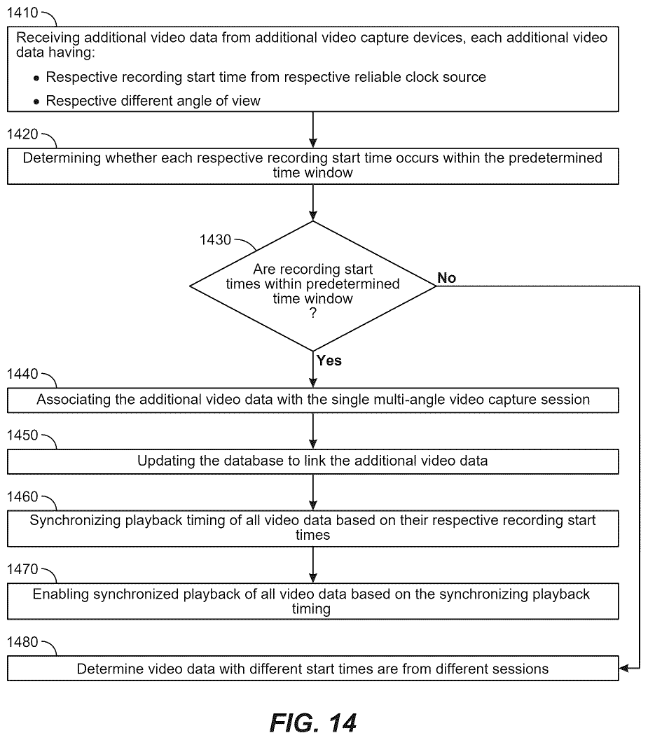

FIG. 14 illustrates an example method flowchart showing how the system handles additional video data from multiple recording devices joining a synchronized session. While this particular process flow provides one implementation technique, various other methods for incorporating additional recordings may be utilized in different embodiments.

The process begins at block 1410 with receiving additional video data from additional video capture devices. Each additional video has its own characteristics: a respective recording start time from a respective reliable clock source and a respective different angle of view. This accommodates scenarios where more than two devices have recorded the same event independently, each using its own local device clock previously synchronized with a reliable time source.

At block 1420, the system determines whether each respective recording start time occurs within the predetermined time window. This analysis expands beyond the initial two-recording comparison to evaluate multiple recording start times simultaneously. For example, if three devices started recording at 1:00:00 PM, 1:00:02 PM, and 1:00:02.5 PM respectively, all fall within the three-second window.

At decision block 1430, the system evaluates whether the recording start times are within the predetermined time window. If they are (YES path), the process continues through several integration steps. At block 1440, the system associates the additional video data with the single multi-angle video capture session. Following this, at block 1450, the system updates the database to link the additional video data with the previously identified related recordings.

The process then moves to block 1460, where the system synchronizes playback timing of all video data based on their respective recording start times. For example, if the latest recording started at 1:00:02.5 PM, earlier recordings will be offset accordingly during playback to maintain temporal alignment. At block 1470, the system enables synchronized playback of all video data based on the synchronizing playback timing.

If any recordings fall outside the time window (NO path), the process moves to block 1480, where the system determines that video data with different start times are from different sessions. This prevents unrelated recordings from being incorrectly associated with the multi-angle session.

In some embodiments, the system may implement algorithms for handling various edge cases, such as when some but not all additional recordings fall within the time window, or when multiple distinct recording sessions overlap in time. The system may also provide mechanisms for manually overriding automatic associations when appropriate.

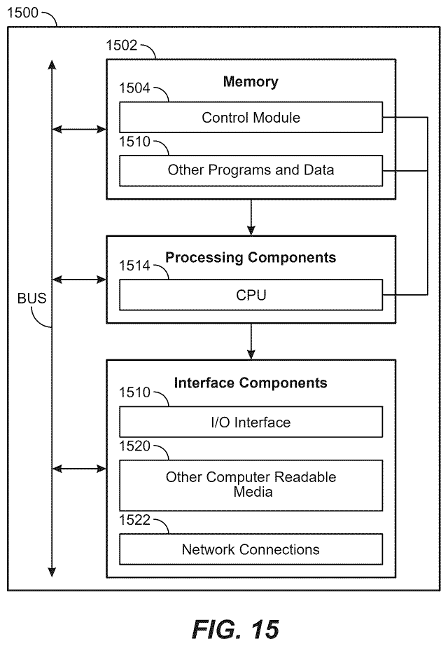

FIG. 15 illustrates an example computer system implementation 1500 that may represent the underlying hardware architecture for any of the system components described throughout this disclosure. This computing architecture may be implemented in recording devices, network components, cloud servers, primary devices, or other system elements. While this particular system architecture provides one implementation technique, various other hardware configurations may be utilized in different embodiments.

The system includes a memory section comprising memory 1502 which may be implemented as a non-transitory computer-readable storage medium having computer-executable instructions stored thereon. When executed by CPU 1514, these instructions may cause the system to perform the various processes, functions, and algorithms described throughout this disclosure. The memory 1502 may store a control module 1504 and other programs and data 1510 that, when executed, implement the described functionality. For example, when implemented in a recording device, the stored instructions may cause the device to maintain video buffers, generate timestamps, and coordinate with other devices. When implemented in a cloud server, the instructions may cause the server to process timing relationships, manage recording sessions, and enable synchronized playback. When implemented in a primary device, the instructions may cause the device to manage device discovery, handle configuration parameters, and coordinate multi-angle recording.

Processing components include a CPU 1514 that executes the stored instructions to implement the various functions. The specific operations performed by CPU 1514 depend on which system component the architecture is implementing. For instance, in a recording device, execution of the instructions causes the CPU to manage video capture and timestamp generation. In a cloud server, execution causes the CPU to analyze timing relationships and group related recordings. In a primary device, execution causes the CPU to coordinate synchronized recording and manage playback.

Interface components include I/O interfaces 1510, other computer readable media 1520, and network connections 1522. These components enable the system to interact with other devices and networks based on the instructions being executed. Network connections 1522 are configured to communicate with other computing devices to facilitate the functionality described herein. In various embodiments, the network connections 1522 may include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1510 may include a video interface, other data input or output interfaces, or other interfaces. Other computer-readable media 1520 may include other types of stationary or removable computer-readable media, such as removable flash drives, external hard drives, or other devices.

For example, execution of the instructions in a camera implementation causes these interfaces to handle video transfer and timing synchronization. In a cloud server, execution causes management of video uploads and downloads. In a primary device, execution enables user interaction and video display.

The components communicate via an internal bus structure, enabling coordinated operation based on the execution of the stored instructions. This architecture may be scaled and adapted based on the specific requirements of each system component, with the stored instructions customized for each implementation role.

In some embodiments, this computing architecture may be virtualized or distributed across multiple physical systems, with the stored instructions appropriately distributed and executed across the multiple systems. The system may also implement various optimization techniques based on its specific role, such as hardware acceleration for video processing or specialized networking protocols for data transfer.

This computing architecture, through its implementation in various system components and execution of its stored instructions, enables the implementation of various features described throughout the application, from local video capture to cloud-based synchronization to multi-angle playback, while adapting to the specific requirements and constraints of each system component.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
transmitting, by a primary device, a trigger to initiate synchronized video recording across multiple video capture devices;
causing each of the multiple video capture devices to begin recording respective videos from different angles of view using configuration parameters provided by the primary device in response to the trigger, wherein each of the multiple video capture devices:
maintains a rolling buffer of locally stored recorded video data; and
timestamps the respective videos using network-synchronized clock data;
causing each of the multiple video capture devices to transfer their recorded videos to the primary device; and
displaying the recorded videos from the multiple video capture devices in a synchronized multi-pane view on the primary device based on the timestamps.

2. The method of claim 1, wherein the configuration parameters include at least one of resolution, frame rate, bit rate, exposure, shutter speed, and focus point.

3. The method of claim 1, wherein the trigger comprises a voice command.

4. The method of claim 1, wherein the trigger comprises input from a remote control BLUETOOTH shutter device.

5. The method of claim 1, wherein the trigger comprises artificial intelligence-based activity detection.

6. The method of claim 1, wherein the multiple video capture devices are discovered by the primary device over a local network.

7. The method of claim 1, wherein the multiple video capture devices are discovered by the primary device through an intermediary server using a shared database containing capture configuration data.

8. The method of claim 1, wherein transferring the recorded videos comprises transmitting the videos over a local network.

9. The method of claim 1, wherein transferring the recorded videos comprises:
uploading the videos from the multiple video capture devices to a cloud server; and
downloading the videos from the cloud server to the primary device.

10. The method of claim 1, wherein the rolling buffer enables storage of video at maximum quality parameters including 4K resolution.

11. The method of claim 1, wherein the rolling buffer enables storage of video at maximum quality parameters including a frame rate of 240 frames per second.

12. The method of claim 1, wherein the primary device comprises a tablet computer.

13. The method of claim 1, wherein the multiple video capture devices comprise at least one of: external cameras, tablet computers, and mobile phones.

14. The method of claim 1, wherein displaying the recorded videos in the synchronized multi-pane view occurs as transfer of the videos completes.

15. The method of claim 1, wherein the configuration parameters are provided to each video capture device before recording begins.

16. The method of claim 1, wherein maintaining the rolling buffer comprises continuously recording and temporarily storing video data locally on each video capture device.

17. The method of claim 1, wherein the network-synchronized clock data is obtained from a network time source before recording begins.

18. A system comprising:
at least one processor; and
at least one memory device coupled to the at least one processor and storing instructions thereon that, when executed by the at least one processor, cause the system to perform operations, the operations including:
transmitting a trigger to initiate synchronized video recording across multiple video capture devices;
causing each of the multiple video capture devices to begin recording respective videos from different angles of view using configuration parameters provided by the system in response to the trigger, wherein each of the multiple video capture devices:
maintains a rolling buffer of locally stored recorded video data; and
timestamps the respective videos using network-synchronized clock data;
causing each of the multiple video capture devices to transfer their recorded videos to the system; and
displaying the recorded videos from the multiple video capture devices in a synchronized multi-pane view based on the timestamps.

19. The system of claim 18, wherein the configuration parameters include at least one of resolution, frame rate, bit rate, exposure, shutter speed, and focus point.

20. The system of claim 18, wherein the trigger comprises a voice command.

21. The system of claim 18, wherein the trigger comprises input from a remote control bluetooth shutter device.

22. The system of claim 18, wherein the trigger comprises artificial intelligence-based activity detection.

23. The system of claim 18, wherein the multiple video capture devices are discovered by the system over a local network.

24. The system of claim 18, wherein the multiple video capture devices are discovered by the system through an intermediary server using a shared database containing capture configuration data.

25. The system of claim 18, wherein transferring the recorded videos comprises transmitting the videos over a local network.

26. The system of claim 18, wherein transferring the recorded videos comprises:
uploading the videos from the multiple video capture devices to a cloud server; and
downloading the videos from the cloud server to the system.

27. The system of claim 18, wherein the rolling buffer enables storage of video at maximum quality parameters including 4K resolution.

28. The system of claim 18, wherein the rolling buffer enables storage of video at maximum quality parameters including a frame rate of 240 frames per second.

29. The system of claim 18, wherein the system comprises a tablet computer.

30. The system of claim 18, wherein the multiple video capture devices comprise at least one of: external cameras, tablet computers, and mobile phones.

31. The system of claim 18, wherein displaying the recorded videos in the synchronized multi-pane view occurs as transfer of the videos completes.

32. The system of claim 18, wherein the configuration parameters are provided to each video capture device before recording begins.

33. The system of claim 18, wherein maintaining the rolling buffer comprises continuously recording and temporarily storing video data locally on each video capture device.

34. The system of claim 18, wherein the network-synchronized clock data is obtained from a network time source before recording begins.

35. A non-transitory computer-readable storage medium having computer-executable instructions stored thereon that, when executed by at least one processor, cause operations to be performed, the operations including:
transmitting a trigger to initiate synchronized video recording across multiple video capture devices;
causing each of the multiple video capture devices to begin recording respective videos from different angles of view using configuration parameters provided in response to the trigger, wherein each of the multiple video capture devices:
maintains a rolling buffer of locally stored recorded video data; and
timestamps the respective videos using network-synchronized clock data;
causing each of the multiple video capture devices to transfer their recorded videos; and
displaying the recorded videos from the multiple video capture devices in a synchronized multi-pane view based on the timestamps.

36. The non-transitory computer-readable storage medium of claim 35, wherein the configuration parameters include at least one of resolution, frame rate, bit rate, exposure, shutter speed, and focus point.

37. The non-transitory computer-readable storage medium of claim 35, wherein the trigger comprises a voice command.

38. The non-transitory computer-readable storage medium of claim 35, wherein the trigger comprises input from a remote control bluetooth shutter device.

39. The non-transitory computer-readable storage medium of claim 35, wherein the trigger comprises artificial intelligence-based activity detection.

40. The non-transitory computer-readable storage medium of claim 35, wherein the multiple video capture devices are discovered over a local network.

41. The non-transitory computer-readable storage medium of claim 35, wherein the multiple video capture devices are discovered through an intermediary server using a shared database containing capture configuration data.

42. The non-transitory computer-readable storage medium of claim 35, wherein transferring the recorded videos comprises transmitting the videos over a local network.

43. The non-transitory computer-readable storage medium of claim 35, wherein transferring the recorded videos comprises:
uploading the videos from the multiple video capture devices to a cloud server; and
downloading the videos from the cloud server.

44. The non-transitory computer-readable storage medium of claim 35, wherein the rolling buffer enables storage of video at maximum quality parameters including 4K resolution.

45. The non-transitory computer-readable storage medium of claim 35, wherein the rolling buffer enables storage of video at maximum quality parameters including a frame rate of 240 frames per second.

46. The non-transitory computer-readable storage medium of claim 35, wherein the multiple video capture devices comprise at least one of: external cameras, tablet computers, and mobile phones.

47. The non-transitory computer-readable storage medium of claim 35, wherein displaying the recorded videos in the synchronized multi-pane view occurs as transfer of the videos completes.

48. The non-transitory computer-readable storage medium of claim 35, wherein the configuration parameters are provided to each video capture device before recording begins.

49. The non-transitory computer-readable storage medium of claim 35, wherein maintaining the rolling buffer comprises continuously recording and temporarily storing video data locally on each video capture device.

50. The non-transitory computer-readable storage medium of claim 35, wherein the network-synchronized clock data is obtained from a network time source before recording begins.

51. The non-transitory computer-readable storage medium of claim 35, wherein the operations are performed by a tablet computer.

52. A method comprising:
receiving, at a server, at least first video data from a first angle of view from a first video capture device and at least second video data from a second angle of view from at least a second video capture device, wherein:
the first video data includes a first recording start time obtained from a first reliable clock source;
the second video data includes a second recording start time obtained from a second reliable clock source; and
the first and second video capture devices operate independently without discovering each other;
determining whether the first recording start time and the second recording start time occur within a predetermined time window;
in response to determining the first and second recording start times occur within the predetermined time window:
associating the first and second video data as belonging to a single multi-angle video capture session; and
updating a database to link the first and second video data;
synchronizing playback timing of the first and second video data based on their respective recording start times; and
enabling synchronized playback of the first and second video data based on the synchronizing playback timing.

53. The method of claim 52, wherein the predetermined time window is approximately three seconds.

54. The method of claim 52, wherein the first and second video capture devices comprise at least one of: external cameras, tablet computers, and mobile phones.

55. The method of claim 52, wherein receiving the first and second video data comprises receiving uploads from the first and second video capture devices when they connect to a network.

56. The method of claim 52, wherein the first and second reliable clock sources comprise network-synchronized clocks.

57. The method of claim 52, wherein synchronizing playback timing comprises offsetting playback start times of the first and second video data based on their respective recording start times.

58. The method of claim 52, wherein the first and second video capture devices are associated with a same user account.

59. The method of claim 52, wherein associating the first and second video data occurs automatically without user input.

60. The method of claim 52, wherein the first and second video data are received at different times.

61. The method of claim 52, wherein enabling synchronized playback comprises providing the synchronized first and second video data to a playback device.

62. The method of claim 52, wherein the first and second video capture devices operate in an offline state during video capture.

63. The method of claim 52, wherein the first and second reliable clock sources comprise local device clocks previously synchronized with a network time source.

64. The method of claim 52, wherein receiving the first and second video data comprises receiving the data via a cloud storage service.

65. The method of claim 52, wherein determining whether the recording start times occur within the predetermined time window occurs automatically when video data is received at the server.

66. The method of claim 52, wherein synchronizing playback timing comprises maintaining relative time offsets between the first and second video data.

67. The method of claim 52, wherein the first and second video data are captured without direct communication between the first and second video capture devices.

68. The method of claim 52, wherein associating the first and second video data comprises storing metadata linking the video data in the database.

69. The method of claim 52, further comprising:
receiving additional video data from additional video capture devices, each additional video data having a respective recording start time from a respective reliable clock source and being from a respective different angle of view;
determining whether each respective recording start time occurs within the predetermined time window;
in response to determining the respective recording start times occur within the predetermined time window:
associating the additional video data with the single multi-angle video capture session; and
updating the database to link the additional video data;
synchronizing playback timing of the first and second video data and the additional video data based on their respective recording start times; and
enabling synchronized playback of the first and second video data and the additional video data based on the synchronizing playback timing.

70. A system comprising:
at least one processor; and
at least one memory device coupled to the at least one processor and storing instructions thereon that, when executed by the at least one processor, cause the system to perform operations, the operations including:
receiving at least first video data from a first angle of view from a first video capture device and at least second video data from a second angle of view from at least a second video capture device, wherein:
the first video data includes a first recording start time obtained from a first reliable clock source;
the second video data includes a second recording start time obtained from a second reliable clock source; and
the first and second video capture devices operate independently without discovering each other;
determining whether the first recording start time and the second recording start time occur within a predetermined time window;
in response to determining the first and second recording start times occur within the predetermined time window:
associating the first and second video data as belonging to a single multi-angle video capture session; and
updating a database to link the first and second video data;
synchronizing playback timing of the first and second video data based on their respective recording start times; and
enabling synchronized playback of the first and second video data based on the synchronizing playback timing.

71. The system of claim 70, wherein the predetermined time window is approximately three seconds.

72. The system of claim 70, wherein the first and second video capture devices comprise at least one of: external cameras, tablet computers, and mobile phones.

73. The system of claim 70, wherein receiving the first and second video data comprises receiving uploads from the first and second video capture devices when they connect to a network.

74. The system of claim 70, wherein the first and second reliable clock sources comprise network-synchronized clocks.

75. The system of claim 70, wherein synchronizing playback timing comprises offsetting playback start times of the first and second video data based on their respective recording start times.

76. The system of claim 70, wherein the first and second video capture devices are associated with a same user account.

77. The system of claim 70, wherein associating the first and second video data occurs automatically without user input.

78. The system of claim 70, wherein the first and second video data are received at different times.

79. The system of claim 70, wherein enabling synchronized playback comprises providing the synchronized first and second video data to a playback device.

80. The system of claim 70, wherein the first and second video capture devices operate in an offline state during video capture.

81. The system of claim 70, wherein the first and second reliable clock sources comprise local device clocks previously synchronized with a network time source.

82. The system of claim 70, wherein receiving the first and second video data comprises receiving the data via a cloud storage service.

83. The system of claim 70, wherein determining whether the recording start times occur within the predetermined time window occurs automatically when video data is received at the system.

84. The system of claim 70, wherein synchronizing playback timing comprises maintaining relative time offsets between the first and second video data.

85. The system of claim 70, wherein the first and second video data are captured without direct communication between the first and second video capture devices.

86. The system of claim 70, wherein associating the first and second video data comprises storing metadata linking the video data in the database.

87. The system of claim 70, wherein the operations further comprise:
receiving additional video data from additional video capture devices, each additional video data having a respective recording start time from a respective reliable clock source and being from a respective different angle of view;
determining whether each respective recording start time occurs within the predetermined time window;
in response to determining the respective recording start times occur within the predetermined time window:
associating the additional video data with the single multi-angle video capture session; and
updating the database to link the additional video data;
synchronizing playback timing of the first and second video data and the additional video data based on their respective recording start times; and
enabling synchronized playback of the first and second video data and the additional video data based on the synchronizing playback timing.

88. A non-transitory computer-readable storage medium having computer-executable instructions stored thereon that, when executed by at least one processor, cause operations to be performed, the operations including:
receiving at least first video data from a first angle of view from a first video capture device and at least second video data from a second angle of view from at least a second video capture device, wherein:
the first video data includes a first recording start time obtained from a first reliable clock source;
the second video data includes a second recording start time obtained from a second reliable clock source; and
the first and second video capture devices operate independently without discovering each other;
determining whether the first recording start time and the second recording start time occur within a predetermined time window;
in response to determining the first and second recording start times occur within the predetermined time window:
associating the first and second video data as belonging to a single multi-angle video capture session; and
updating a database to link the first and second video data;
synchronizing playback timing of the first and second video data based on their respective recording start times; and
enabling synchronized playback of the first and second video data based on the synchronizing playback timing.

89. The non-transitory computer-readable storage medium of claim 88, wherein the predetermined time window is approximately three seconds.

90. The non-transitory computer-readable storage medium of claim 88, wherein the first and second video capture devices comprise at least one of: external cameras, tablet computers, and mobile phones.

91. The non-transitory computer-readable storage medium of claim 88, wherein receiving the first and second video data comprises receiving uploads from the first and second video capture devices when they connect to a network.

92. The non-transitory computer-readable storage medium of claim 88, wherein the first and second reliable clock sources comprise network-synchronized clocks.

93. The non-transitory computer-readable storage medium of claim 88, wherein synchronizing playback timing comprises offsetting playback start times of the first and second video data based on their respective recording start times.

94. The non-transitory computer-readable storage medium of claim 88, wherein the first and second video capture devices are associated with a same user account.

95. The non-transitory computer-readable storage medium of claim 88, wherein associating the first and second video data occurs automatically without user input.

96. The non-transitory computer-readable storage medium of claim 88, wherein the first and second video data are received at different times.

97. The non-transitory computer-readable storage medium of claim 88, wherein enabling synchronized playback comprises providing the synchronized first and second video data to a playback device.

98. The non-transitory computer-readable storage medium of claim 88, wherein the first and second video capture devices operate in an offline state during video capture.

99. The non-transitory computer-readable storage medium of claim 88, wherein the first and second reliable clock sources comprise local device clocks previously synchronized with a network time source.

100. The non-transitory computer-readable storage medium of claim 88, wherein receiving the first and second video data comprises receiving the data via a cloud storage service.

101. The non-transitory computer-readable storage medium of claim 88, wherein determining whether the recording start times occur within the predetermined time window occurs automatically when video data is received.

102. The non-transitory computer-readable storage medium of claim 88, wherein synchronizing playback timing comprises maintaining relative time offsets between the first and second video data.

103. The non-transitory computer-readable storage medium of claim 88, wherein the first and second video data are captured without direct communication between the first and second video capture devices.

104. The non-transitory computer-readable storage medium of claim 88, wherein associating the first and second video data comprises storing metadata linking the video data in the database.

105. The non-transitory computer-readable storage medium of claim 88, wherein the operations further comprise:
receiving additional video data from additional video capture devices, each additional video data having a respective recording start time from a respective reliable clock source and being from a respective different angle of view;
determining whether each respective recording start time occurs within the predetermined time window;
in response to determining the respective recording start times occur within the predetermined time window:
associating the additional video data with the single multi-angle video capture session; and
updating the database to link the additional video data;
synchronizing playback timing of the first and second video data and the additional video data based on their respective recording start times; and
enabling synchronized playback of the first and second video data and the additional video data based on the synchronizing playback timing.
